(19) United States
(12) Patent Application Publication
(10) Pub. No.: US 2005/0266196 A1
(43) Pub. Date: Dec. 1, 2005

(54) Means for identifying the unused portion of rolled material

(76) Inventors: Van R. Foster II, Westerville, OH (US); Connie S. Foster, Westerville, OH (US)

Correspondence Address: MCNEES, WALLACE & NURICK LLC, 100 PINE STREET, P.O. BOX 1166, HARRISBURG, PA, 17108-1166, US

(21) Appl. No.: 11/130,762

(22) Filed: May 17, 2005

Related U.S. Application Data
(60) Provisional application No. 60/571,848, filed on May 17, 2004.

(51) Int. Cl. B32B 31/00

(52) U.S. Cl. 428/40.1; 156/64

(57) ABSTRACT

Apparatus and methods for keeping track of the number of self-adhesive materials remaining on coil are provided. The apparatus provides means for indicating to a user of the quantity of items such as self-adhesive labels or amount of tape remaining on a coiled roll.

### CROSS-REFERENCE TO RELATED APPLICATIONS

This application claims the benefit of U.S. Provisional Patent Application No. 60/571,848 filed May 17, 2004.

### FIELD OF THE INVENTION

The present invention is directed to apparatus and methods for keeping track of the number of items remaining on coil of dispensable articles. More specifically, the invention relates to a means for reminding a user of the number of self-adhesive labels such as stamps or stickers remaining on a coiled roll or within a dispenser.

### BACKGROUND OF THE INVENTION

It has long been a problem to keep track of how many items remain on a spool or coil of items that are dispensed from the free end of the coil. For example, some items that are preferably dispensed from a coil include such things as postage stamps, return address labels, stickers and the like. Postage stamps have historically been sold in coils having a predetermined number, typically 100. Stamps may be gummed and perforated or may be supplied in a peel-off configuration removably attached to a backing strip which is then coiled up for storage. Small plastic dispensers, and even more elaborate and decorative types of containers, have been made available to both store and provide a convenient dispensing means for the coiled items. Unfortunately, these types of dispensers, although convenient for storing and dispensing the coiled products have no means for tracking either the number of items dispensed or the number of items that remain on the roll. Shortcomings can lead to the inconvenience associated with unexpectedly running out of postage stamps when they are needed and perhaps at a time of day when they cannot be easily replaced.

What is needed is a simple and inexpensive way of being able to keep track of how many stamps or other similar coiled items remain on a roll and provide a periodic reminder to the user of the relative number of coiled items remain on the roll within a dispenser.

### SUMMARY OF THE INVENTION

The present invention solves the problem of not knowing how many dispensable items are remaining in a coil. In addition to keeping track of either the number used or the number remaining, the invention can provide the user with periodic reminders within the coil of the percentage of remaining items or warnings about attending to a replenishment of the coiled items to avoid unexpected shortcomings. Warnings may be provided in a number of fashions such as text messages, color-coding or a combination of both.

In one embodiment, the invention comprises a coiled roll of self-adhesive labels, the coiled roll comprising a predetermined quantity of self-adhesive labels, a label backing having a first surface that is a release surface, and at least one label quantity indicator. As used herein, “self-adhesive” labels includes any label that can be adhered to a surface, such as pressure-sensitive labels, gummed labels that may require wetting, and heat-activated adhesive labels. Exemplary self-adhesive labels include postage stamps, decorative stamps, novelty labels, stickers, inventory labels, barcodes, and warning labels. Preferably, the at least one label quantity indicator is comprised of at least one code that corresponds to a predetermined percentage of labels remaining on the roll. The code may be comprised of at least one color, at least one symbol, and any combination thereof. In one embodiment, the at least one indicator is applied to the first release surface of the backing prior to the assembly of the self-adhesive labels, so that the indicator is visible to a user when the self-adhesive label is removed. In another embodiment, the at least one indicator is applied to the surface opposite the release surface of the backing prior to the assembly of the self-adhesive labels, so that the indicator is visible to a user prior to removal of any self-adhesive label. The at least one indicator may be comprised of at least one reminder that instructs a user to order additional labels.

In another embodiment, the invention includes methods of indicating the quantity of labels remaining on a coiled roll. Preferably, the method comprises the steps of: providing a predetermined quantity of self-adhesive labels; providing a label backing, the label backing having a first surface that is a release surface; providing at least one label quantity indicator; and adhering the self-adhesive labels and the at least one label quantity indicator to the first release surface of the label backing to form a coiled roll.

In another embodiment, the invention comprises a roll of self-adhesive material, the roll comprising a predetermined length of self-adhesive sheet material coiled around a cylindrical core. At least one quantity indicator is applied to the sheet material, the quantity indicator representing at least one of the amount of sheet material remaining on the roll or the amount of sheet material dispensed from the roll. Preferably, the sheet material is a pressure sensitive tape. More preferably, the quantity indicator is at least one of color-coding, symbols, numerals, and reminders.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

Further features of the present invention will become apparent to those skilled in the art to which the present invention relates from reading the following specification with reference to the accompanying drawings, in which:

FIG. 1 depicts a number of items that are packaged and dispensed from coiled rolls and some of the typical dispensers that may be employed;

FIG. 2 depicts typical dispensers for postage stamps and boxed stickers demonstrating the difficulty in being able to estimate the amount of inventory remaining on the respective rolls;

FIG. 3 demonstrates the use of color-coding as an indication of the level of remaining inventory;

FIG. 4 depicts a roll of stamps affixed to a backing that is marked and color coded according to an embodiment of the present invention; and

FIG. 5 represents a reminder that may be found on a portion of the rolled inventory or its backing that indicates how much inventory remains on the roll with a suggestion to replenish.

### DETAILED DESCRIPTION OF THE INVENTION

In the discussion that follows, like reference numerals will be used to identify components of like structure in the Figures, if applicable.

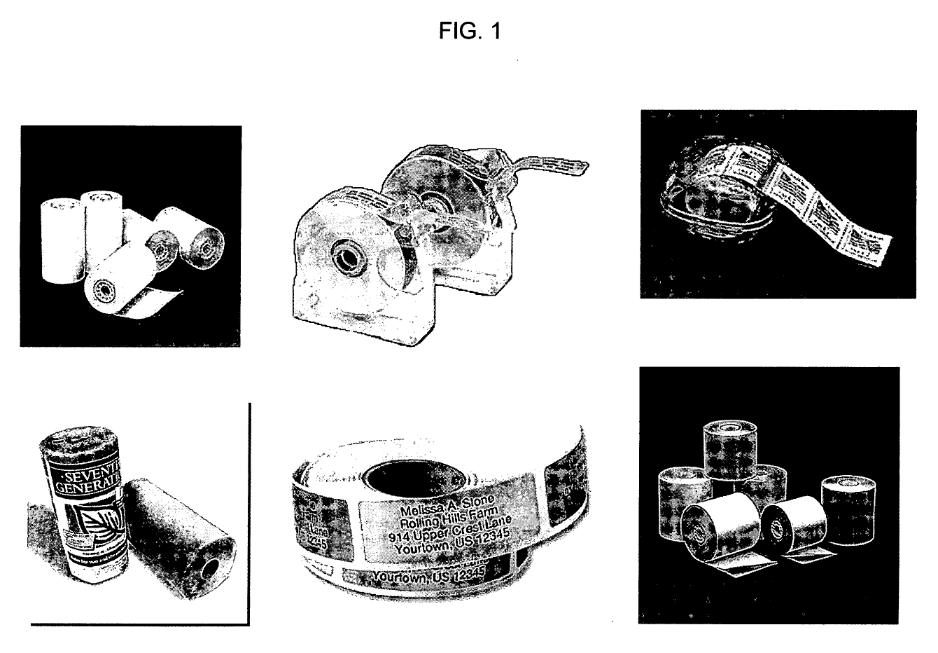

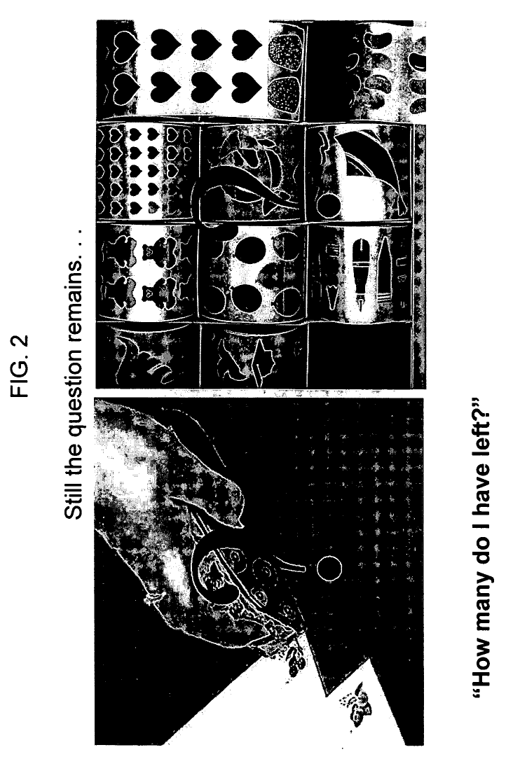

Referring first to FIGS. 1 and 2, a number of dispensable items stored in rolled or coiled form is therein depicted. Of particular note are the coils of labels and stamps which are shown being housed in dispensers. As can be appreciated, while the total number of dispensable items may be known initially, once items are dispensed from the rolls, there is no simple and convenient way of keeping track of the number of items either used or remaining on the roll. In reference to the boxed rolls of stickers shown on the right portion of FIG. 2, the number of remaining stickers would be very difficult to estimate without removing the coiled roll from its dispensing box and doing a physical accounting. This would defeat the purpose of the manner of storage and would subject the rolled items to being soiled or otherwise rendered undesirable.

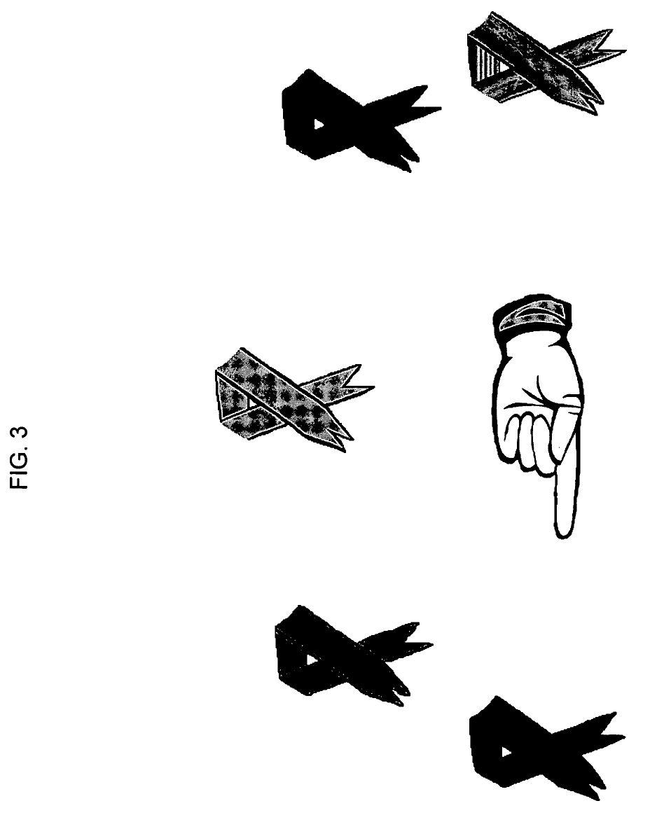

In FIG. 3, one aspect of the invention is depicted using color-coding to provide a visual feedback to the user as to the condition of inventory remaining on the dispensing roll. In the color-coding depicted in the Figure, blue may be used to represent the initial 25% portion dispensed from a new roll. Next, the color green could be used to indicate that there was 75% of inventory remaining on the roll. Similarly, yellow and red may be used to represent other percentages of remaining inventory, such as 50% and 25% respectively. However, it should be appreciated that any color combination could be adopted to represent any number of percentages of either used or remaining inventory to give the user some idea of whether it is getting close to the time that the inventory should be replenished.

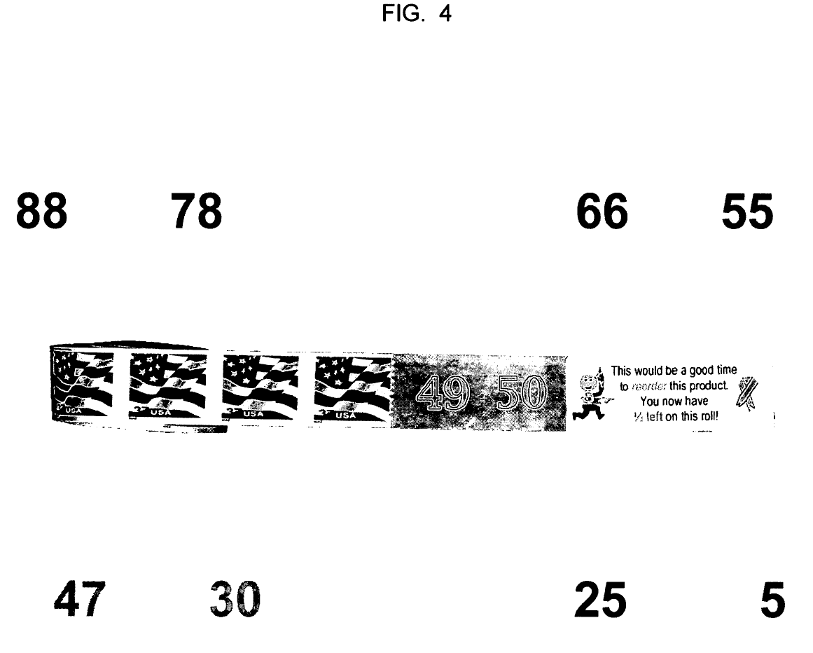

Referring additionally to FIG. 4, there is depicted a roll of postage stamps of the peel-off variety, in which, according to another embodiment of the invention, the number of remaining stamps in the roll is indicated on the underlying backing to which the stamps are mounted. In this embodiment both color and numerical indicators are coupled to provide both a visual and quantitative assessment of the remaining inventory. As can be seen in the figure, the yellow numerals 49 and 50 provide both quantitative and color coded feedback as to the level of remaining inventory of stamps on the roll. In addition, a reminder can be seen in the rightmost area of the backing strip to alert the user that it may be time to reorder or otherwise replenish the supply of inventory. Also shown in the FIG. 4 is the use of blue numerals 88 and 78 to represent the initial 25% of the roll: 66 and 55 being used to demonstrate use between 50 and 75%; yellow numerals 47 and 30 as representative of use between 50 and 25%; and the red numerals 25 and 5 as indicators that the inventory is in the 25 to 0% range.

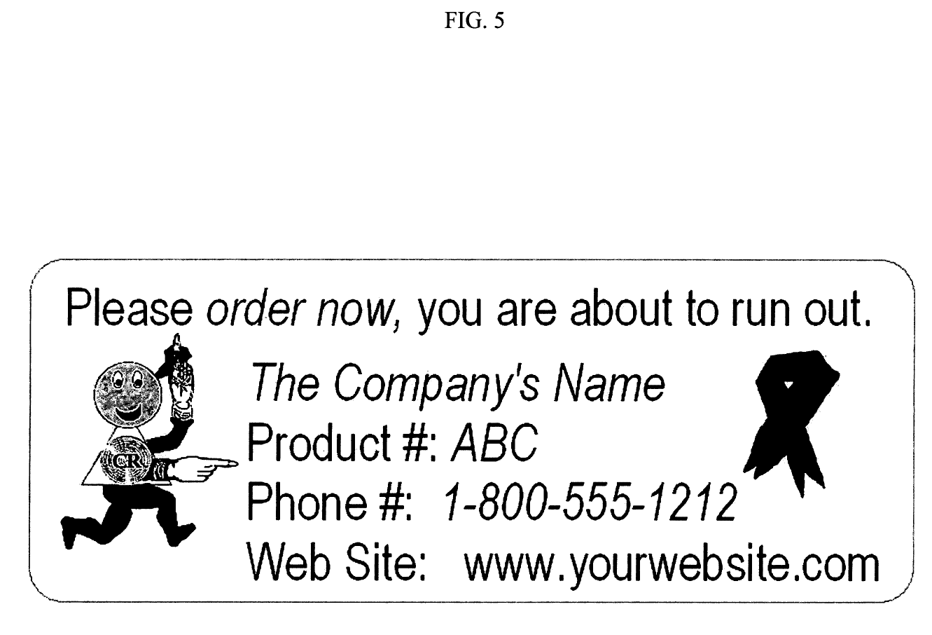

In addition to providing notice that it may be time to replenish the rolled inventory, the periodic alert may also provide the user with additional information such as the name, phone number or even an Internet related address for re-ordering supplies, as shown in FIG. 5. These periodic labels may also be used to advertise related products, provide coupons for discounts on related products or utilized to educate or inform the user with factual information.

Referring once again to FIG. 4, the postage stamps are shown as being the peel off type of stamps that are mounted on an easily separable backing. Even so, one embodiment of the invention provides for similar indicators of remaining inventory to be printed on the back of the dispensed item which may be provided as a gummed product needing to be moistened before being applied. Such items are well known in the art, such as rolls of gummed stamps with perforations located between adjacent stamps. Thus in this embodiment, the remaining inventory indicators, such as color-coding and numerical information, may be printed directly to the reverse of the postage stamps, observable to the user prior to transfer and application of the item to its intended mount.

From the above description of the invention, those skilled in the art will perceive improvements, changes, and modifications that may be made in the invention. Such improvements, changes, arid modifications within the skill of the art are intended to be covered within the scope of that which is disclosed herein. While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A coiled roll of self-adhesive labels, the coiled roll comprising:
a predetermined quantity of self-adhesive labels;
a label backing having a first surface that is a release surface; and
a label quantity indicator;
wherein the self-adhesive labels and the label quantity indicator are applied to the label backing to form a coiled roll.

2. The coiled roll of claim 1, wherein the self-adhesive labels are selected from the group consisting of postage stamps, decorative stamps, novelty labels, stickers, inventory labels, barcodes, and warning labels.

3. The coiled roll of claim 2, wherein the label quantity indicator is comprised of a code that corresponds to a predetermined quantity of labels remaining on the roll.

4. The coiled roll of claim 3, wherein the code is comprised of a color.

5. The coiled roll of claim 3, wherein the code is comprised of a symbol.

6. The coiled roll of claim 3, wherein the code is comprised of a color and a symbol.

7. The coiled roll of claim 1, wherein the indicator is applied to the first release surface of the backing prior to the applying of the self-adhesive labels.

8. The coiled roll of claim 1, wherein the indicator is applied to the surface opposite the first release surface of the backing.

9. The coiled roll of claim 1, wherein the indicator is comprised of a reminder that instructs a user to order additional labels.

10. A method of indicating the quantity of labels remaining on a coiled roll, the method comprising the steps of:
providing a predetermined quantity of self-adhesive labels;
providing a label backing, the label backing having a first surface that is a release surface;
providing a label quantity indicator; and
applying the self-adhesive labels and the label quantity indicator to the first release surface of the label backing to form a coiled roll.

11. The method of claim 10, wherein the self-adhesive labels are selected from the group consisting of postage stamps, decorative stamps, novelty labels, stickers, inventory labels, barcodes, and warning labels.

12. The method of claim 11, wherein the label quantity indicator is comprised of a code that corresponds to a predetermined quantity of labels remaining on the roll.

13. The method of claim 12, wherein the code is comprised of a color.

14. The method of claim 12, wherein the code is comprised of a symbol.

15. The method of claim 12, wherein the at code is comprised of a color and a symbol.

16. The method of claim 10, wherein the indicator is applied to the first release surface of the backing prior to applying the self-adhesive labels.

17. The method of claim 10, wherein the indicator is applied to a surface opposite the first release surface of the backing.

18. The method of claim 10, wherein the indicator is comprised of a reminder that instructs a user to order additional labels.

19. A roll of self-adhesive material, the roll comprising:
a predetermined length of self-adhesive sheet material coiled around a cylindrical core; and
a quantity indicator applied to the sheet material, the quantity indicator selected from the group consisting of a representation of the amount of sheet material remaining on the roll, a representation of the amount of sheet material dispensed from the roll, and combinations thereof.

20. The roll of claim 19, wherein the sheet material is a pressure sensitive tape, and wherein the quantity indicator is at least one of color-coding, symbols, numerals, and reminders.
